(19) United States
(12) Patent Application Publication
(10) Pub. No.: US 2024/0168155 A1
(43) Pub. Date: May 23, 2024

(54) DETERMINING THE LOCATIONS OF COMPONENTS OF A LOCATION-DETERMINING SYSTEM IN AN ENVIRONMENT

(71) Applicant: Ubisense Limited, Cambridge (GB)

(72) Inventors: Rupert Meldrum Curwen, Cambridgeshire (GB); Peter Joseph Steggles, Cambridgehshire (GB); Andrew Martin Robert Ward, Cambridgeshire (GB)

(21) Appl. No.: 18/279,734

(22) PCT Filed: Mar. 2, 2022
(86) PCT No.: PCT/GB2022/050550

§ 371 Date: Aug. 31, 2023

(30) Foreign Application Priority Data
Mar. 2, 2021 (GB) 2102939.2

(51) Int. Cl. G01S 13/89; G01S 7/00

(52) U.S. Cl. CPC G01S 13/89; G01S 7/003

(57) ABSTRACT

A method for determining the locations of components of a location-determining system in an environment, the method comprising: providing a surveying device comprising: (i) a ranging subsystem comprising a transmitter and a receiver configured to receive signals transmitted by the receiver and reflected off objects in the environment whereby a three-dimensional map of the shape of the environment can be generated; (ii) a communication subsystem configured for transmitting signals to the said components or detecting signals from the said components; moving the surveying device in the environment whilst operating the ranging subsystem and the communication subsystem; and causing one or more processors to: (i) form the said three-dimensional map of the environment; and (ii) correlate that map with data received by or from the sensors to determine the positions of the sensors.

This invention relates to characterising objects in an environment. In one example the objects could be transmitters or receivers or passive markers for a location-determining system.

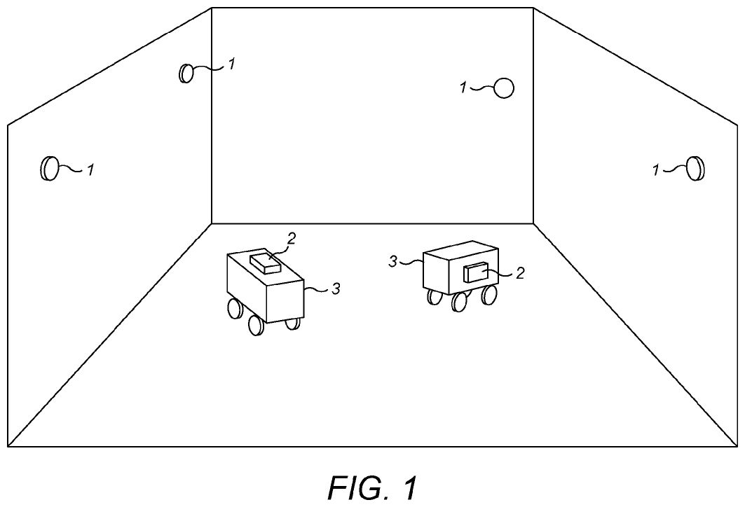

FIG. 1 shows one form of location-determining system. The system comprises multiple sensors 1 which are located at fixed, known positions in an environment. In this example the environment is a room. The system also comprises transmitters 2. The transmitters are carried by units 3 whose locations in the environment are to be tracked. The sensors 1 receive signals from the transmitters 2. Because the locations of the sensors are known, the system can determine the locations of the transmitters using, for example, the time or angle of arrival of signals from the transmitters at the sensors.

When a system of this type is installed, the sensors are attached to suitable structures in the environment. Then there is a need to collect data defining the locations of the sensors. That data will subsequently be used to determine the locations of the transmitters. Collecting the data can be time-consuming. It is typically done by surveying the environment using laser triangulation: measuring the distances and directions of the sensors from one or more datum points.

In the example given above, the sensors are at fixed locations and the transmitters are mobile. Other approaches are possible. For example, the transmitters could be at fixed locations and the sensors could be carried by the units whose locations are to be tracked. Another approach is to have fixed, passive markers in the environment which can be recognised by a detector carried by the units whose locations are to be tracked.

There is a need for an improved method for surveying an environment to determine where location devices are sited.

According to one aspect there is provided a method as set out in the accompanying claims. According to another aspect there is provided a system as set out in the accompanying claims. Other features are set out in the description below, and may be claimed irrespective of whether they are individually explicitly identified as aspects of the invention in the present description.

There is provided method for determining the locations of one or more components of a location-determining system in an environment, the method comprising:
providing a surveying device comprising:
   (i) a ranging subsystem comprising a transmitter and a receiver configured to receive signals transmitted by the receiver and reflected off objects in the environment whereby a three-dimensional map of the shape of the environment can be generated; and
   (ii) a communication subsystem configured for transmitting signals to the said one or more components or detecting signals from the said one or more components;
moving the surveying device in the environment whilst operating the ranging subsystem and the communication subsystem; and
causing one or more processors to:
(i) form the said three-dimensional map of the environment; and
(ii) correlate that map with data received by or from the one or more components to determine the positions of the one or more components.

The correlating step may comprise comparing, over time, one or more signal characteristics of the signals received by or from the one or more components as made when the surveying device was at multiple locations.

The one or more signal characteristics may comprise one or more of: a time at which a signal is received by or from the one or more components, a time-of-flight of a signal received by or from the one or more components, a time difference of arrival of a signal received at two different receivers, and a direction from which a signal is received by or from the one or more components.

The surveying device may comprise a clock, the one or more components may each comprise a clock, and, for a component of the one or more components, a timing offset between the clock comprised by the surveying device and the clock comprised by the component may be known.

The surveying device may comprise a clock, the one or more components may each comprise a clock, and the method may further comprise determining, for a component of the one or more components, a timing offset between the clock comprised by the surveying device and the clock comprised by the component.

Determining the timing offset between the clock comprised by the surveying device and the clock comprised by the component may comprise:
maintaining a histogram representing a plurality of estimated timing offsets by, for each estimated timing offset:
   identifying two instances in time where one or more of the measured characteristics of the signals received by or from the component are substantially the same;
   identifying two instances in time where the location or path trajectory of the surveying device is substantially the same; and
   in response to determining that a time difference according to the clock comprised by the component between the two signal characteristic instances is substantially equal to a time difference according to the clock comprised by the surveying device between the two location or path trajectory instances, incrementing a bin of the histogram that represents a time difference between the first of the two signal characteristic instances according to the clock comprised by the component and the first of the two location or path trajectory instances according to the clock comprised by the surveying device, that time difference being an estimated timing offset; and
determining the timing offset between the clock comprised by the surveying device and the clock comprised by the component in dependence on the maintained histogram.

The correlating step may further comprise determining, for a component of the one or more components, at least one aspect of the orientation of that component.

The correlating step may comprise determining the yaw aspect of the orientation of that component.

The roll and/or pitch aspects of the orientation of that component may be determined by an orientation sensor associated with that component.

The correlating step may further comprise determining, for a component of the one or more components of the location-determining system, a timing offset between that component and another component of the location-determining system, said timing offset being due to signal propagation delays in a network used to synchronise a clock comprised by the component and a clock comprised by said another component.

The method described herein may comprise refining the determined locations of the one or more components by, for at least one of the components:
forming an initial determination of that component's position; and
searching the three-dimensional map in at least the region of that initially determined position for a shape corresponding to the shape of the component; and
adopting the position of that shape in the three-dimensional map as the determined position of the component.

The surveying device may move autonomously.

The one or more components may be sensors configured to receive signals from a transmitter attached to the surveying device; the one or more components may be transmitters configured to transmit signals to a sensor attached to the surveying device; or the one or more components may be passive markers configured to reflect signals to a detector attached to the surveying device.

The positions of the one or more components may be determined absolutely; or the positions of the one or more components may be determined relatively.

The positions of the one or more components may be determined relatively with reference to one of the components of the location-determining system or with reference to a starting location of the surveying device.

The method described herein may further comprise providing a user interface via which a user can verify or adjust the determined positions of the one or more components.

The signals may be radio signals. The signals may be ultra-wideband radio signals.

The method may be for determining the locations of components of the location-determining system in the environment, the communication subsystem may be configured for transmitting signals to the said components or detecting signals from the said components, and the one or more processors may be caused to correlate that map with data received by or from the components to determine the positions of the components.

There is also provided a system configured to determining the locations of one or more components of a location-determining system in an environment, the system comprising:
a surveying device comprising:
   (i) a ranging subsystem comprising a transmitter and a receiver configured to receive signals transmitted by the receiver and reflected off objects in the environment whereby a three-dimensional map of the shape of the environment can be generated; and
   (ii) a communication subsystem configured for transmitting signals to the said one or more components or detecting signals from the said one or more components;
   wherein the surveying device is configured to move in the environment whilst operating the ranging subsystem and the communication subsystem; and
one or more processors configured to:
   (i) form the said three-dimensional map of the environment; and
   (ii) correlate that map with data received by or from the one or more components to determine the positions of the one or more components.

In an example, there is also provided a method for determining the locations of components of a location-determining system in an environment, the method comprising:
providing a surveying device comprising:
(i) a ranging subsystem comprising a transmitter and a receiver configured to receive signals transmitted by the receiver and reflected off objects in the environment whereby a three-dimensional map of the shape of the environment can be generated;
(ii) a communication subsystem configured for transmitting signals to the said components or detecting signals from the said components;
moving the surveying device in the environment whilst operating the ranging subsystem and the communication subsystem; and
causing one or more processors to:
(i) form the said three-dimensional map of the environment; and
(ii) correlate that map with data received by or from the sensors to determine the positions of the sensors.

The method may comprise refining the determined locations of the sensors by, for at least one of the sensors:
forming an initial determination of that sensor's position; and
searching the three-dimensional map in at least the region of that initially determined position for a shape corresponding to the shape of the sensor; and
adopting the position of that shape in the three-dimensional map as the determined position of the sensor.

The present invention will now be described by way of example with reference to the accompanying drawings. In the drawings:

FIG. 1 shows an overview of a location-determining system.

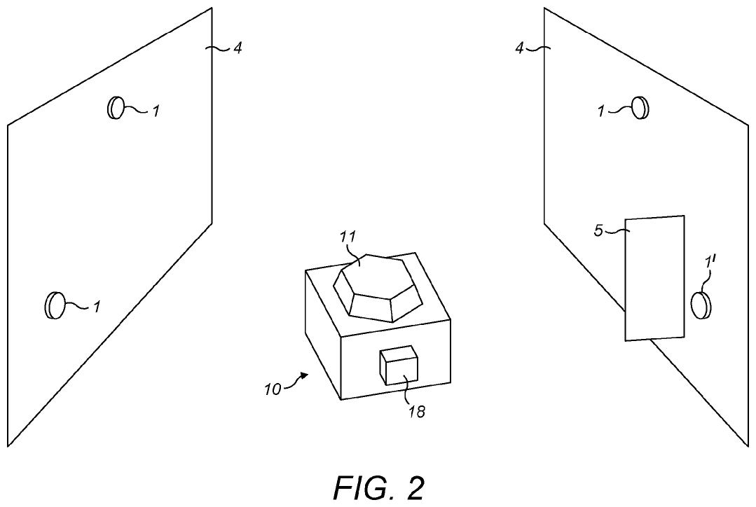

FIG. 2 is a schematic view of a location-determining system during a surveying operation.

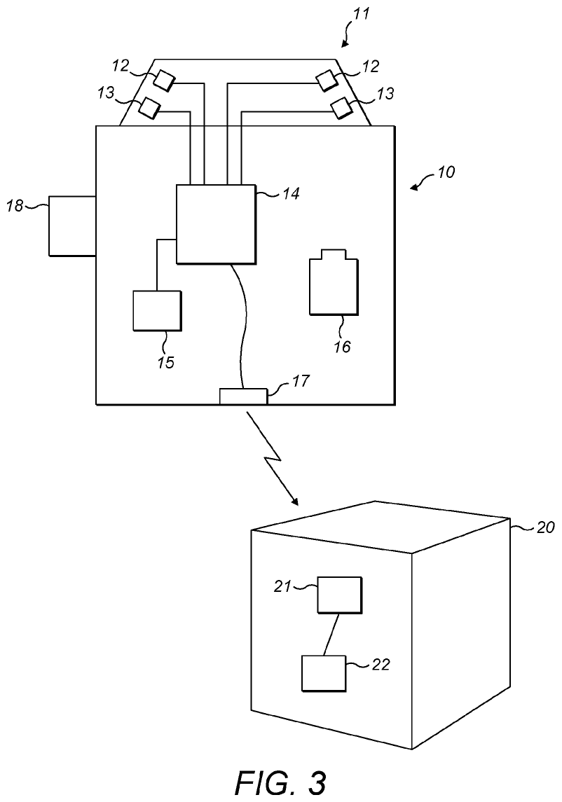

FIG. 3 shows a surveying device and a data processing unit.

FIG. 2 shows an environment in which sensor devices 1 have been installed. A surveying device 10 is being used to determine the locations of the sensors. The surveying device is a mobile unit. It has a scanning unit 11 which can generate a map of the shape of the environment. That scanner could be of any suitable type. One example is a laser scanner or LIDAR unit. The surveying device is moved around the environment. As it is moved, it scans the shape of the environment. The surveying device also carries a transmitter 18. The transmitter 18 transmits signals that can be detected by the sensors 1. A transmitter may be referred to herein as a tag. A transmitter may transmit radio signals, such as ultra-wideband radio signals (e.g. UWB signals). Information detected by the sensors as they receive transmissions from the transmitter 18 is correlated with information captured by the scanning unit. This allows the locations of the sensors to be determined.

In more detail, FIG. 2 shows an environment in which sensors 1 are installed. The sensors could be attached with adhesive or physical couplings such as screws to static elements of the environment. Examples of such elements include walls 4, ceilings and fixed machinery. In a real environment It can be anticipated that some sensors will be obscured from certain locations. For example, in FIG. 2 sensor 1′ may be obscured by an object 5 from some locations. In order for the sensors to function as a location-determining system it is desirable for their locations to be known. In some location-determining systems it may be possible to estimate the locations of objects if the locations of some or all of the sensors 1 are not known, but if the locations of the sensors are known this can make determining the locations of other objects quicker or more accurate. The sensors cooperate with each other to implement a location-determining system of the type described above with reference to FIG. 1. The sensors 1 receive signals from transmitters that are carried by units whose locations are desired to be known. When a sensor receives a signal it detects characteristics of the received signal. One example of such a characteristic is the time at which the signal was received. If the time when the signal was transmitted is known, e.g. because clocks of the receiving sensor and the respective transmitter have a known offset, the time taken for the signal to reach the sensor can be estimated. That can provide an indication of the distance from the transmitter to that sensor. Or, if the time when the signal was transmitted is not known, the relative time-of-arrival (the ‘time difference of arrival’) of the signal at two receiving sensors (whose clocks have a known offset) can provide an indication (a ‘pseudorange’) of the difference in distance from the transmitter to each of the two sensor. Another example of such a characteristic is the direction from which the transmitted signal has been received. That may be estimated using a phased receiver antenna array or other mechanisms. The sensors can communicate with each other and/or with a server so that data collected by the sensors can be aggregated. Distance, pseudorange and/or direction estimates from multiple sensors in respect of a single transmitter can be combined, based on the known locations of the sensors, to provide an estimate of the transmitter's location.

FIG. 3 shows the surveying device 10 in more detail. The surveying device comprises the scanning unit 11, a processor 14, a memory 15, a battery 16, an interface 17 and the transmitter 18.

In this example the scanning unit 11 is a laser scanner, sometimes known as a LIDAR scanner. The laser scanner comprises one or more laser emitters 12 and one or more laser receivers 13. The emissions from the laser emitters are pulsed or otherwise varied over time so that when a transmission from an emitter 12 is reflected off an object in the environment and received back at a receiver 13 the time taken for that round trip can be estimated. This provides an indication of the distance to that object in the environment. The direction in which the or each emitter 12 emits light varies over time. To achieve this the scanning unit may be driven by a motor to spin relative to the body of the surveying device 10. Each distance measurement made by the scanning unit represents a point in the environment from which light has been reflected. Over time, the scanning unit can build up many such measurements. They constitute a spatial point cloud representing the three-dimensional physical shape of the environment including the objects in it.

The surveying device is portable. It can be moved around the environment. For example it may be mounted on a wheeled cart, which can be pushed by a user or can move autonomously. Alternatively, it may be carried on an article that can be worn by a user, such as a backpack. Because the surveying device is mobile it can capture the shape of the environment from multiple locations. One consequence of this is that it can image parts of the environment that are obscured from some locations, e.g. by object 5. Another consequence is that the spatial point clouds built up in different locations can be correlated to improve accuracy. As the surveying device is moved, features in the spatial point cloud it captures can be compared with those in previously-captured spatial point clouds. That can enable the movement of the surveying device to be estimated. That movement estimate may be improved by combining it with information from acceleration sensors which may optionally be included in the surveying device. The battery 16 powers the surveying device as it moves around.

The memory 15 stores in a non-transient way instructions that are executable by the processor 14 to permit it to perform its functions. Those functions may include controlling the spatial scanning unit 11, processing data received from the spatial scanning unit and causing data received from the spatial scanning unit to be transmitted via interface 17 for remote processing.

A data processing device 20 is available. It comprises a processor 21 and a memory 22. The memory stores in a non-transient way instructions that are executable by the processor 21 to permit it to perform its functions. The data processing device can receive data from the surveying device and from sensors 1. It combines that data to generate an estimate of the sensors' locations. That estimate may later be used to estimate the location of transmitters 2.

The location of transmitters 2 may be determined in numerous ways. One example will be given.
1. From time to time each transmitter transmits a signal. That signal may be part of a discontinuous transmission or may be data contained in a continuous or extended transmission. The signal is transmitted in a wireless manner, for example by radio. The signal is received by multiple sensors. The time at which the signal is received by each sensor depends on the distance of that sensor from the transmitter.
2. Each sensor that receives the signal measures the time-of-arrival of the signal from the transmitter.
3. By comparing the time-of-arrival of the same transmitter signal at different sensors, whose locations are known, it is possible to estimate the transmitter's location. To achieve this the sensors may have clocks that are synchronised with each other or have known offsets from each other or the sensors may immediately report the receipt of the signal to a central unit and the central unit may estimate the time-of-arrival from knowledge of any signalling delay between the reporting sensor and the central unit. For example, the sensors' clocks may be perfectly synchronised, with zero fixed timing offset. If a signal from a transmitter is measured to arrive at the same time at sensors A and B, then it can be inferred that the transmitter is equidistant from A and B. In practice, sensors are synchronised using a signal which is distributed to them (from some timing source) over a cabled network. This is not necessarily a “star-wired” network from some central location. It could be “daisy-chained” from one sensor to the next, or some arbitrary combination of star- and daisy-chain cabling. The distributed clock source ensures that the frequencies of the sensor clocks are locked together (i.e. the clocks “tick” at the same rate). But there are still fixed offsets between the clocks at different sensors, due to the delays (due to the finite speed of signal propagation) of the signal along the timing cables. This may represent an additional unknown in the position computation. For example, suppose a tag is equidistant from sensors A and B. The clocks of sensors A and B are synchronised over the cabled network, with different delays (dA and dB). The time of arrival of a transmission from the tag is measured at A and B as tA and tB. Then (tA−dA)=(tB−dB). It is desirable to know dA and dB in order to infer tA and tB. In the present system, information about the position of a tag (as determined by the surveying device) is combined with observations of the time-of-arrival of the signals at sensors, observations of the angles-of-arrival of the signals at sensors, any information about the sensor orientation obtained through other means (e.g. accelerometers) and other information about the sensor positions obtained through other means (e.g. direct identification in laser scan data) to solve for the unknown cable delays. To illustrate: if the locations of the sensors were known precisely, as was the location of the tagged survey device. Then, the radio signal propagation time from the tag to different sensors could be computed, and then the measured times-of-arrival of the signal at different sensors could be compared with these propagation times to determine the (unknown but fixed) timing cable delays. In general, the same process used to determine the sensor locations using the sensor measured data and the survey device data could be used to find both the sensor locations, orientations and timing cable offsets at the same time. The computation of the sensor cable timing delays, sensor orientations and sensor locations can be performed as an ensemble optimization.

It is not essential to provide a central processing unit. If the sensors are synchronised and their clock timing offsets are known, sensors can exchange messages regarding signal times-of-arrival. One or more sensors can then perform location estimation itself.

The system operates as follows.

Once the sensors 1 have been installed, the surveying device is moved in the environment. It captures three-dimensional point maps of the environment, and an estimate of its movement path so that the relative locations from which those maps were captured are known. Meanwhile, the transmitter 18 makes transmissions which are received by the sensors 1. The sensors detect information characteristic of the transmissions from the transmitter (e.g. their direction and/or time-of-flight).

The information collected by the surveying device and the sensors is combined. This may be done in any suitable location. Conveniently it can be done at data processor 20.

The information collected by the surveying device and the sensors is correlated to determine the locations of the sensors. The locations may be determined absolutely or with reference to some arbitrary datum such as one of the sensors or a starting location of the surveying device. Some ways in which this may be done, which may be used individually or in any combination, are as follows. In each case a best-fit or minimisation process may be used to form an overall estimate.
1. The surveying device may have a clock that has a known offset to those of the sensors. This allows the system to know where the surveying device was along its movement path when measurements were made by the sensors. With that information, distances and/or directions from the sensors to the transmitter 18 carried by the surveying device can be compared over time, as made when the surveying device was at multiple locations, and the locations of the sensors thereby estimated. In other words, at a point in time, from the information collected by the surveying device, the position of the surveying device relative to the environment can be determined. At the same point in time, from the information collected by the sensors, the position of the sensors relative to transmitter carried by the surveying device can be determined. Hence, by correlating, for that point in time, the information indicating position of the surveying device relative to the environment and the information indicating the position of the sensors relative to transmitter carried by the surveying device, the position of the sensor relative to the environment can be estimated.
2. The path moved by the surveying device may deviate over time. For example, it may include bends in two or three dimensions. The data collected by the sensors may indicate similar changes. For example, by comparing distance information from two sensors over time it may be seen that the surveying device has moved in a bend, or changed speed. By comparing the path detected by the surveying device and deviations in the movement of the sensing device the relative timings of the measurements from the sensors and the surveying device may be inferred. Then the locations of the sensors can be estimated by correlating the two sets of data. This can avoid the need to synchronise the surveying device with the sensors. In another example, the relative timings of the measurements from the sensors and the surveying device can alternatively or additionally be inferred as follows. It may be estimated when the surveying device has revisited a location in the environment (e.g. a point in space). For example, the surveying device may move autonomously and may perform multiple “laps” of the same path about the environment. Alternatively, the surveying device may be moved autonomously, or manually by a user, and revisit a location in the environment (e.g. intentionally or coincidentally). A “candidate revisit” may be identified by determining, for measurements taken greater than a threshold period of time apart (e.g. greater than 10 seconds apart), two instances in time where one or more of the characteristics of the signals received at a sensor (e.g. angle-of-arrival, time-of-arrival or, where the timing offset (if any) between the clocks of that sensor and at least one other are known, time-difference-of-arrival) are substantially the same (e.g. within five degrees in azimuth and/or elevation angle for angle-of arrival characteristics, or within three nanoseconds in time-difference-of-arrival or time-of-arrival characteristics), and two instances in time where the location or path trajectory (e.g. the first differential of the location with respect to time) of the surveying device is substantially the same (e.g. within 1 meter in location or within 0.2 m/s along any of the orthogonal basis vectors of the reference frame in which the path trajectory is measured). Each “candidate revisit” may be associated with a time offset. For example, the time according to a sensor's clock at which a first signal having a characteristic is received at that sensor (or reported by the sensor to another unit) can be t₁ and the time at which a second signal having substantially the same characteristic is received at that sensor (or reported by the sensor to another unit) can be t₂. Hence, a measure of time (e.g. time difference) between these two receiving events can be expressed as t₁-t₂. The time according to the surveying device's clock at which a first location is visited or path trajectory is used can be t₃ and the time at which a second, substantially the same, location is visited or path trajectory is used can be t₄. Hence, a measure of time (e.g. time difference) between these two location or path trajectory events can be expressed as t₃-t₄. It can be determined whether t₁-t₂ is substantially equal to (e.g. within 10 seconds of, more preferably within 5 seconds of) t₃-t₄. For each “candidate revisit” where it is determined that t₁-t₂ is substantially equal to t₃-t₄, this means that these measurements are more likely to be associated with the same location in the environment, and so the time offset between the clocks of the sensor and the surveying device expressed by t₁-t₃ (or t₂-t₄) is more likely to be accurate indication of the time offset between (e.g. relative timings of) the measurements from the sensor and the surveying device. A histogram may be maintained, having bins for various estimated time offsets (e.g. values for t₁-t₃). One histogram may be maintained per sensor. Alternatively, where two or more sensors are known to have synchronised clocks, estimated time offsets identified using receiving events measured at those two or more sensors may be collated in a single histogram. Each time a “candidate revisit” is identified for which it is determined that t₁-t₂ is substantially equal to t₃-t₄, the respective bin in the histogram having the value of t₁-t₃ (or t₂-t₄) can be incremented (e.g. by one). After assessing a number of candidate revisits, it can be determined that the bin(s) on the histogram that have been incremented the greatest number of times are more likely to be accurate indications of the time offset between (e.g. the relative timings of) the measurements from the sensor and the surveying device. The time offset used to correlate data collected by the sensor and the surveying device may be the time offset associated with the most incremented bin of the histogram. Alternatively, the time offsets associated with a plurality of the most incremented bins can be averaged or combined (e.g. using a weighted sum, weighted based on the number of times each associated bin has been incremented) so as to provide a value of the time offset to be used to correlate data collected by the sensor and the surveying device. As described herein, once the time offset between measurements taken by a sensor and measurements taken by the surveying device has been estimated, then the location of the sensor can be estimated by correlating the two sets of data measured by the sensor and surveying device (e.g. the signal characteristics measured by the sensor and contemporaneously measured locations of the surveying device).
3. The information derived from the sensors 1 may be more readily combined if the orientation of each sensor is fully or partially known. Each sensor 1 may include an orientation sensor, for example a gravity sensor. Information from such a sensor may be used to help correlate the distances and/or directions provided by the sensors with each other and with the path information provided by the surveying device. If the orientation of a sensor is known then it may be better able to help determine the location and/or orientation of another device. The orientation of a sensor may be expressed as its pitch, roll and yaw in space. Those angles may be expressed relative to a reference orientation fixed in the environment. Pitch and roll (using normal conventions) can be determined by using accelerometer measurements on the sensor to compare the device's orientation with the local gravity vector. Yaw (rotation around the local gravity vector) cannot be measured simply in that way. That that component of the sensor orientation can be calibrated using an aggregate set of laser scanner and sensor measurements.
4. Once the location of a sensor has been estimated using a technique as described above, the accuracy of that estimation may be improved by searching one or more of the three-dimensional maps formed by the surveying device. The points in such a map that lie near the estimated sensor location can be analysed to identify a shape that matches the shape of the sensor. That shape may be pre-programmed into the device performing the analysis. Once such a shape is located, the distance from the surveying device to that sensor is known, being represented in the three-dimensional map. The location along the surveying device's path from which the distance was measured is also known. The estimate of the location of the sensor can be refined in dependence on that measurement. The estimate of location of the sensor can be further refined in dependence on such distance measurements made at multiple times. This process may be assisted if the sensor has a characteristic shape. Such a shape may make it easier to identify the sensor in the three-dimensional maps. For example, the sensor could have an outer rim or surface of a predetermined regular or more preferably irregular polygonal shape. Or it could have a recess of a predetermined shape. In one example, the exterior surface of the sensor could comprise multiple planar faces with at least two, three or four adjacent faces being angled at greater than 90 degrees to each other. Optionally, additionally or alternatively, once the location of a sensor has been estimated using a technique as described above, a user of the system may visually confirm (e.g. via a user interface), whether the estimated locations of the sensors appear to be accurate. The user (e.g. via the user interface) may indicate that one or more of the estimated positions appear to be accurate, indicate that one or more of the estimated positions appear to be inaccurate, and/or adjust one or more of the estimated positions (e.g. to a position they consider to more accurately define the position of a sensor). This user input step may be performed before or after the three-dimensional maps formed by the surveying device have been searched based on the initial position estimates for the sensors. Optionally, after receiving input from the user, one or more steps of the method for estimating the position of the sensors may be repeated in dependence on the user input (e.g. so as to determine improved estimates of the sensor positions). Alternatively or additionally, the system may be capable of machine learning, and may learn from the user input so as to improve future sensor position estimates. In other examples, the user input step may be performed before any data is collected by the sensors and/or the surveying device.

As described herein, a location determining system may comprise multiple sensors. The system and methods described herein may be used to estimate the positions of all of the sensors in a location determining system. Alternatively, the system and methods described herein may be used to estimate the positions of a subset of (e.g. fewer than all of) the sensors in a location determining system. In an example, the system and methods described herein may be used to estimate the position of a single sensor in a location determining system. Optionally, a user of the system may be able to select which sensor(s) in a location determining system are to have their positions estimated and which sensor(s) are not. For example, this may be useful when one or more sensors are added to an existing a location determining system (e.g. in replacement of one or more former sensors of that system, or as new sensors in that system). The positions of the other sensors in that location determining system may already be known—and so it may not be desirable to re-estimate the positions of all of the sensors in that system. Hence, in this example the system and methods described herein may be used to estimate the positions of only the one or more sensors added to a location determining system.

In the description above, the sensors (receivers) are fixed and a transmitter is attached to the surveying unit. Other arrangements are possible. Multiple transmitters could be fixed in the environment and a sensor (receiver) could be attached to the surveying unit. Or multiple fixed passive markers could be fixed in the environment which can be detected (e.g. by reflection from the sensors) by a detector attached to the surveying unit.

In the examples discussed above, data from the surveying device is used to help determine the locations of the sensors. Other data relating to the sensors could be determined with the aid of the surveying device. Some examples are:
1. The orientation of a sensor may be determined in dependence on data from the surveying device. When the surveying device is in the environment a sensor may estimate the direction of the surveying device relative to the sensor and report that to a device that can correlate data from the sensor with data from the surveying device. Since the location of the surveying device in the environment is known, and the location of the sensor in the environment can be determined with the aid of the surveying device, the orientation of the surveying device relative to the sensor with reference to the environment can be determined. The offset between the direction of the surveying device relative to the sensor as reported by the sensor and the direction of the surveying device relative to the sensor with reference to the environment can be used to correct directions subsequently reported by the sensor.
2. The sensor may report its measurements to a central unit 20 for processing. Those measurements may include timing data. In order for the central unit to synchronise the sensor with a reference clock, or to know the timing offset between the sensor and the reference clock or the clock of another sensor, it may be helpful for the central unit 20 to know the delay between signals being transmitted from the sensor and arriving at the central unit 20. This delay or offset may be estimated in any of multiple ways. First, the location of the central unit in the environment may be determined by the surveying device and/or input to the central unit by a user. Then when the location of a sensor in the environment is known, the distance between the sensor and the central unit can be determined. In a first approach, this distance may be taken to be proportional to the timing delay. Second, each sensor may receive signals from transmitters on devices to be located and may report those signals to the central unit for processing. The relative timings of those signals as received by the central unit may be used to estimate the location of the transmitter by trilateration. The sensors are reporting on a common transmitted signal, so the offsets between the times when the signals are received can provide a representation of the distance between the transmitter and a respective sensor. The time at which a reception report is received at the central unit 20 can be considered to be delayed from the time at which the signal was transmitter by T+P+C where T is the propagation delay of the signal between the transmitter and the sensor, P is a processing delay at the sensor which may be assumed to be constant and C is the delay in propagation of signal, e.g. through cabling, between the sensor and the central unit. When the surveying device is in the environment and its transmitter 18 transmits a signal, that signal may be detected by a sensor and reported to the central unit 20. Since the distance between the transmitter and the sensor is known, the propagation time T of the signal from the transmitter to the sensor can be estimated. The processing time P may be known to the central unit 20. The surveying device can report to the central unit the time when it transmitted the signal. The central unit 20 knows when it received the report from the sensor. By subtracting T from the difference between the transmission time and the time when the signal was received by the central unit, the magnitude of other delays such as P and C can be estimated. The central unit may store a value for that delay and may use that stored value to correct subsequent data reported by the sensor. Third, each sensor may have a flashing light that may indicate ticks of a clock local to the sensor. Illumination of that light may be detected by the surveying device and reported to the central unit 20 to permit the central unit to estimate the timing of the sensor's local clock.

The signalling delay for signals to a sensor may also be useful for adjusting the sensor's clock. If the signalling delay from a device that is setting the clock to the respective sensor is known then the clock can be set more precisely since the time of arrival of a clock-setting signal at the respective sensor can be estimated.

The surveying unit could use techniques other than laser ranging to form a map of the shape of the environment. For example, it could use ultrasonic ranging.

In some examples, it may be desirable to determine one or more of the following about a sensor in a location determining system: (1) its position in the environment (e.g. an absolute or relative position, such as in x, y and z coordinates); (2) its orientation (e.g. in (i) roll, (ii) pitch and/or (iii) yaw); and/or (3) its timing offsets due to signal propagation delays (if any) relative to one or more other sensors or a central unit of the location determining system. The system and methods described herein may be used to estimate the position of a sensor (i.e. (1)) by correlating the sets of data measured by the sensors and the surveying device (e.g. the signal characteristics measured by the sensor and contemporaneously measured locations of the surveying device), as described herein. In a preferred example, the location of the sensor can be estimated by correlating angle-of-arrival signal characteristics measured at the sensor with the contemporaneously measured locations of surveying device. Optionally, the system and methods described herein may also be used to determine the orientation of a sensor (e.g. in (i) roll, (ii) pitch and/or (iii) yaw) by correlating the sets of data measured by the sensors and the surveying device, as described herein. Alternatively again, also optionally, the roll and pitch (i.e. (2)(i) and (ii)) of a sensor may be determined by an orientation sensor (e.g. a gravity sensor or accelerometer) associated with that sensor, as described herein. Optionally, the timing offsets due to signal propagation delays (i.e. (3)—if any) associated with a sensor may be known or determined separately, and may be provided as an input to the system and methods described herein. Alternatively, also optionally, the system and methods described herein may be used to estimate the timing offsets due to signal propagation delays (i.e. (3)—if any) associated with a sensor by correlating the sets of data measured by the sensors and the surveying device, as described herein. In a preferred example, the system and methods described herein may be used to estimate, for a sensor, its position in the environment (e.g. an absolute or relative position, such as in x, y and z coordinates), (2) its orientation in (iii) yaw, and (3) its timing offset(s) due to signal propagation delays (if any) relative to one or more other sensors or a central unit of the location determining system by correlating the sets of data measured by the sensors and the surveying device, as described herein. In this preferred example, that sensor's orientation in (i) roll and (ii) pitch may be determined by an orientation sensor (e.g. a gravity sensor or accelerometer) associated with that sensor.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for determining the locations of one or more components of a location-determining system in an environment, the method comprising:
providing a surveying device comprising:
(i) a ranging subsystem comprising a transmitter and a receiver configured to receive signals transmitted by the transmitter and reflected off objects in the environment whereby a three-dimensional map of the shape of the environment can be generated; and
(ii) a communication subsystem configured for transmitting signals to the said one or more components or detecting signals from the said one or more components;
moving the surveying device in the environment whilst operating the ranging subsystem and the communication subsystem; and
causing one or more processors to:
(i) form the said three-dimensional map of the environment; and
(ii) correlate that map with data received by or from the one or more components to determine the positions of the one or more components.

2. A method as claimed in claim 1, wherein the correlating step comprises comparing, over time, one or more signal characteristics of the signals received by or from the one or more components as made when the surveying device was at multiple locations.

3. A method as claimed in claim 2, wherein the one or more signal characteristics comprise one or more of: a time at which a signal is received by or from the one or more components, a time-of-flight of a signal received by or from the one or more components, a time difference of arrival of a signal received at two different receivers, and a direction from which a signal is received by or from the one or more components.

4. A method as claimed in claim 2, wherein the surveying device comprises a clock, the one or more components each comprise a clock, and, for a component of the one or more components, a timing offset between the clock comprised by the surveying device and the clock comprised by the component is known.

5. A method as claimed in claim 2, wherein the surveying device comprises a clock, the one or more components each comprise a clock, and the method further comprises determining, for a component of the one or more components, a timing offset between the clock comprised by the surveying device and the clock comprised by the component.

6. A method as claimed in claim 5, wherein determining the timing offset between the clock comprised by the surveying device and the clock comprised by the component comprises:
maintaining a histogram representing a plurality of estimated timing offsets by, for each estimated timing offset:
identifying two instances in time where one or more of the measured characteristics of the signals received by or from the component are substantially the same;
identifying two instances in time where the location or path trajectory of the surveying device is substantially the same; and
in response to determining that a time difference according to the clock comprised by the component between the two signal characteristic instances is substantially equal to a time difference according to the clock comprised by the surveying device between the two location or path trajectory instances, incrementing a bin of the histogram that represents a time difference between the first of the two signal characteristic instances according to the clock comprised by the component and the first of the two location or path trajectory instances according to the clock comprised by the surveying device, that time difference being an estimated timing offset; and
determining the timing offset between the clock comprised by the surveying device and the clock comprised by the component in dependence on the maintained histogram.

7. A method as claimed in claim 1, wherein the correlating step further comprises determining, for a component of the one or more components, at least one aspect of the orientation of that component.

8. A method as claimed in claim 7, wherein the correlating step comprises determining the yaw aspect of the orientation of that component.

9. A method as claimed in claim 7, wherein the roll and/or pitch aspects of the orientation of that component are determined by an orientation sensor associated with that component.

10. A method as claimed in claim 1, wherein the correlating step further comprises determining, for a component of the one or more components of the location-determining system, a timing offset between that component and another component of the location-determining system, said timing offset being due to signal propagation delays in a network used to synchronise a clock comprised by the component and a clock comprised by said another component.

11. A method as claimed in claim 1, comprising refining the determined locations of the one or more components by, for at least one of the components:
forming an initial determination of that component's position; and
searching the three-dimensional map in at least the region of that initially determined position for a shape corresponding to the shape of the component; and
adopting the position of that shape in the three-dimensional map as the determined position of the component.

12. A method as claimed in claim 1, wherein the surveying device moves autonomously.

13. A method as claimed in claim 1, wherein:
the one or more components are sensors configured to receive signals from a transmitter attached to the surveying device;
the one or more components are transmitters configured to transmit signals to a sensor attached to the surveying device; or
the one or more components are passive markers configured to reflect signals to a detector attached to the surveying device.

14. A method as claimed in claim 1, wherein:
the positions of the one or more components are determined absolutely; or
the positions of the one or more components are determined relatively.

15. A method as claimed in claim 14, wherein the positions of the one or more components are determined relatively with reference to one of the components of the location-determining system or with reference to a starting location of the surveying device.

16. A method as claimed in claim 1, further comprising providing a user interface via which a user can verify or adjust the determined positions of the one or more components.

17. A method as claimed in claim 1, wherein the signals are radio signals.

18. (canceled)

19. A method as claimed in claim 1, wherein the method is for determining the locations of components of the location-determining system in the environment, the communication subsystem is configured for transmitting signals to the said components or detecting signals from the said components, and the one or more processors are caused to correlate that map with data received by or from the components to determine the positions of the components.

20. A system configured to determining the locations of one or more components of a location-determining system in an environment, the system comprising:
a surveying device comprising:
(i) a ranging subsystem comprising a transmitter and a receiver configured to receive signals transmitted by the transmitter and reflected off objects in the environment whereby a three-dimensional map of the shape of the environment can be generated; and
(ii) a communication subsystem configured for transmitting signals to the said one or more components or detecting signals from the said one or more components;
wherein the surveying device is configured to move in the environment whilst operating the ranging subsystem and the communication subsystem; and
one or more processors configured to:
(i) form the said three-dimensional map of the environment; and
(ii) correlate that map with data received by or from the one or more components to determine the positions of the one or more components.

21. A method for determining the locations of components of a location-determining system in an environment, the method comprising:
providing a surveying device comprising:
(i) a ranging subsystem comprising a transmitter and a receiver configured to receive signals transmitted by the transmitter and reflected off objects in the environment whereby a three-dimensional map of the shape of the environment can be generated;
(ii) a communication subsystem configured for transmitting signals to the said components or detecting signals from the said components;
moving the surveying device in the environment whilst operating the ranging subsystem and the communication subsystem; and
causing one or more processors to:
(i) form the said three-dimensional map of the environment; and
(ii) correlate that map with data received by or from the components to determine the positions of the components.
